(19) United States
(12) Patent Application Publication
(10) Pub. No.: US 2024/0005394 A1
(43) Pub. Date: Jan. 4, 2024

(54) METHODS AND SYSTEMS FOR INTEGRATED BANKING, ACCOUNTING, AND TAX DATA PROCESSING

(71) Applicant: Michelle Ann Diaz, New Orleans, LA (US)

(72) Inventor: Michelle Ann Diaz, New Orleans, LA (US)

(21) Appl. No.: 17/856,900

(22) Filed: Jul. 1, 2022

(51) Int. Cl. G06Q 40/02; G06Q 40/00; G06V 30/18

(52) U.S. Cl. CPC G06Q 40/02; G06Q 40/123; G06V 30/18; G06V 30/41

(57) ABSTRACT

Computer-implemented integrated banking, accounting, and tax methods, systems, and computer-readable media are described.

### FIELD

Some implementations are generally related to financial software, and, more particularly, to methods and systems for integrated banking, accounting, and tax data processing.

### BACKGROUND

Some conventional baking, accounting, and tax data processing systems are separate systems that may suffer from inefficiencies caused by data silos (e.g., banking versus accounting versus tax). Also, such conventional systems may require users to re-enter or import information into multiple software applications such as banking versus accounting versus tax. Further, some conventional systems may require a reconciliation of disparate systems (e.g., banking, accounting, and/or tax). Also, some conventional systems may require significant manual work to overcome the above-mentioned problems among other things.

The background description provided herein is for the purpose of generally presenting the context of the disclosure. Work of the presently named inventor(s), to the extent it is described in this background section, as well as aspects of the description that may not otherwise qualify as prior art at the time of filing, are neither expressly nor impliedly admitted as prior art against the present disclosure.

### SUMMARY

Some implementations can include a computer-implemented method comprising receiving one or more electronic data items representing one or more corresponding transactions, and programmatically mapping each of the one or more transactions to corresponding entries in banking, accounting and tax data. The method can also include automatically updating banking, accounting, and tax data based on the received electronic data and the programmatic mapping.

In some implementations, programmatically mapping includes, when data correspond to one of the one or more corresponding transactions includes an image, performing an optical character recognition operation on the image to extract one or more items of information from the image to utilize in the programmatically mapping. In some implementations, programmatically mapping includes categorizing the one or more transactions based on one or more of a merchant industry code.

In some implementations, programmatically mapping includes categorizing the one or more transactions based on previous categorization of similar transactions by one or more users. In some implementations, programmatically mapping includes categorizing the one or more transactions based on a machine learning model signal, where the machine learning model is trained to predict categorization using previous categorization of one or more transactions.

The method can further include generating a bank statement that includes one or more of accounting information or tax return line item category corresponding to a transaction in the bank statement. The method can also include computing a required tax payment and corresponding due date based on programmatically mapping and automatically updating and generating a notification of the required tax payment and due date.

Some implementations can include a system comprising one or more processors coupled to a computer-readable medium having stored thereon software instructions that, when executed by the one or more processors, cause the one or more processors to perform operations. The operations can include receiving one or more electronic data items representing one or more corresponding transactions, and programmatically mapping each of the one or more transactions to corresponding entries in banking, accounting and tax data. The operations can also include automatically updating banking, accounting, and tax data based on the received electronic data and the programmatic mapping.

In some implementations, the programmatically mapping includes, when data correspond to one of the one or more corresponding transactions includes an image, performing an optical character recognition operation on the image to extract one or more items of information from the image to utilize in the programmatically mapping. In some implementations, programmatically mapping includes categorizing the one or more transactions based on one or more of a merchant industry code.

In some implementations, programmatically mapping includes categorizing the one or more transactions based on previous categorization of similar transactions by one or more users. In some implementations, programmatically mapping includes categorizing the one or more transactions based on a machine learning model signal, where the machine learning model is trained to predict categorization using previous categorization of one or more transactions.

The operations can further include generating a bank statement that includes one or more of accounting information or tax return line item category corresponding to a transaction in the bank statement. The operations can also include computing a required tax payment and corresponding due date based on the programmatically mapping and automatically updating and generating a notification of the required tax payment and due date.

Some implementations can include a computer-readable medium having stored thereon software instructions that, when executed by one or more processors, cause the one or more processors to perform operations. The operations can include receiving one or more electronic data items representing one or more corresponding transactions, and programmatically mapping each of the one or more transactions to corresponding entries in banking, accounting and tax data. The operations can also include automatically updating banking, accounting, and tax data based on the received electronic data and the programmatic mapping.

In some implementations, the programmatically mapping includes, when data correspond to one of the one or more corresponding transactions includes an image, performing an optical character recognition operation on the image to extract one or more items of information from the image to utilize in the programmatically mapping. In some implementations, programmatically mapping includes categorizing the one or more transactions based on one or more of a merchant industry code.

In some implementations, programmatically mapping includes categorizing the one or more transactions based on previous categorization of similar transactions by one or more users. In some implementations, programmatically mapping includes categorizing the one or more transactions based on a machine learning model signal, where the machine learning model is trained to predict categorization using previous categorization of one or more transactions.

The operations can further include generating a bank statement that includes one or more of accounting information or tax return line item category corresponding to a transaction in the bank statement. The operations can also include computing a required tax payment and corresponding due date based on the programmatically mapping and automatically updating and generating a notification of the required tax payment and due date.

### BRIEF DESCRIPTION OF THE DRAWINGS

FIG. 1 is a block diagram of an example system and a network environment which may be used for one or more implementations described herein.

FIG. 2 is a diagram of an example banking, accounting, and tax integrated application in accordance with some implementations.

FIG. 3 is a diagram of example submodules of a banking, accounting, and tax integrated application in accordance with some implementations.

FIG. 4 is a flowchart of an example method for integrated banking, accounting, and tax data processing in accordance with some implementations.

FIG. 5 is a block diagram of an example computing device which may be used for one or more implementations described herein.

### DETAILED DESCRIPTION

Some implementations include integrated banking, accounting, and tax data processing tasks methods and systems.

In some implementations, the disclosed methods and systems can provide a seamless integration of (a) banking; (b) accounting; and (c) tax return preparation functions.

As used herein, banking can include, but is not limited to, native banking or digital wallet connected to a pre-existing bank account. Tax return as used herein can include, but is not limited to, a federal, state and/or local tax return. Accounting as used herein can include but is not limited to income or sales tax accounting. Transactions, as used herein, can include, but are not limited to, any financial transaction such as checks or cash received or disbursed, card transactions, journal entries, etc.

To accomplish this integration, some implementations permit transactions to be “mapped.” For example, mapping can include automatically processing electronic transaction data from its provenance to the appropriate line of the tax return form. In another example, a bank deposit can be automatically mapped to increase the “Revenue” line item on a tax return with no further input needed by the user. In another example, a card charge at an office supply store can be automatically populated onto the “Office Supplies” expense line of the tax return form with no further input needed by the user.

In some implementations, the mapping technology described herein eliminates inefficiencies caused by data silos (e.g., between banking versus accounting versus tax data silos or applications). Some implementations can reduce or eliminate a need for re-entering or importing information into multiple software/applications. Further, some implementations can reduce or eliminate a need to reconcile disparate systems.

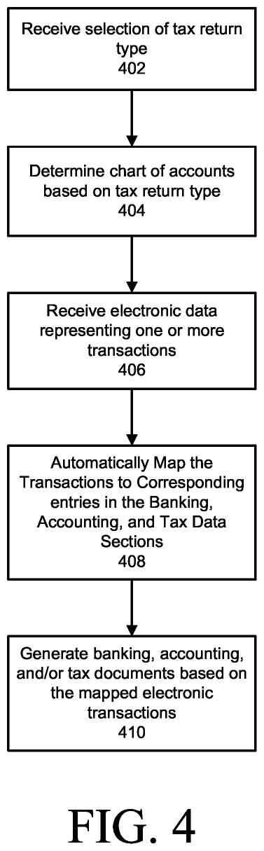

When performing integrated banking, accounting, and tax data processing functions, it may be helpful for a system to suggest and/or to make predictions about categorizing electronic transaction data and/or mapping electronic transactions into corresponding banking, accounting, and tax data. To make predictions or suggestions, a probabilistic model (or other model as described below in conjunction with FIG. 4) can be used to make an inference (or prediction) about aspects of electronic transaction data such as categorization and/or mapping as described herein. Accordingly, it may be helpful to make an inference regarding a probability that a user would categorize a transaction in a predicted way. Other aspects can be predicted or suggested as described below.

The inference based on the probabilistic model can include predicting electronic transaction data categorization and/or mapping in accordance with image (or other data) analysis and confidence score as inferred from the probabilistic model. The probabilistic model can be trained with data including previous transaction categorization or mapping data.

Some implementations may provide a technical solution to one or more technical problems with some conventional individual banking, accounting, and tax systems, data may be processed in “silos,” which may result in inefficiencies such as duplicate storage of data, increased processor utilization, and/or increased network data transfer as described above in the Background section.

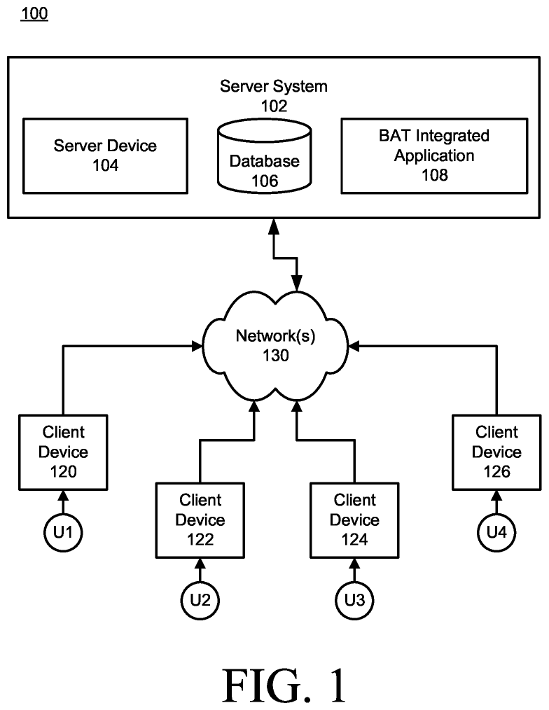

FIG. 1 illustrates a block diagram of an example network environment 100, which may be used in some implementations described herein. In some implementations, network environment 100 includes one or more server systems, e.g., server system 102 in the example of FIG. 1A. Server system 102 can communicate with a network 130, for example. Server system 102 can include a server device 104, a database 106 or other data store or data storage device, and a banking, accounting, and tax integrated application 108. Network environment 100 also can include one or more client devices, e.g., client devices 120, 122, 124, and 126, which may communicate with each other and/or with server system 102 via network 130. Network 130 can be any type of communication network, including one or more of the Internet, local area networks (LAN), wireless networks, switch or hub connections, etc. In some implementations, network 130 can include peer-to-peer communication 132 between devices, e.g., using peer-to-peer wireless protocols.

For ease of illustration, FIG. 1 shows one block for server system 102, server device 104, and database 106, and shows four blocks for client devices 120, 122, 124, and 126. Some blocks (e.g., 102, 104, 106, and 108) may represent multiple systems, server devices, and network databases, and the blocks can be provided in different configurations than shown. For example, server system 102 can represent multiple server systems that can communicate with other server systems via the network 130. In some examples, database 106 and/or other storage devices can be provided in server system block(s) that are separate from server device 104 and can communicate with server device 104 and other server systems via network 130. Also, there may be any number of client devices. Each client device can be any type of electronic device, e.g., desktop computer, laptop computer, portable or mobile device, camera, cell phone, smart phone, tablet computer, television, TV set top box or entertainment device, wearable devices (e.g., display glasses or goggles, head-mounted display (HMD), wristwatch, headset, armband, jewelry, etc.), virtual reality (VR) and/or augmented reality (AR) enabled devices, personal digital assistant (PDA), media player, game device, etc. Some client devices may also have a local database similar to database 106 or other storage. In other implementations, network environment 100 may not have all of the components shown and/or may have other elements including other types of elements instead of, or in addition to, those described herein.

In various implementations, end-users U1, U2, U3, and U4 may communicate with server system 102 and/or each other using respective client devices 120, 122, 124, and 126. In some examples, users U1, U2, U3, and U4 may interact with each other via applications running on respective client devices and/or server system 102, and/or via a network service, e.g., an image sharing service, a messaging service, a social network service or other type of network service, implemented on server system 102. For example, respective client devices 120, 122, 124, and 126 may communicate data to and from one or more server systems (e.g., server system 102). In some implementations, the server system 102 may provide appropriate data to the client devices such that each client device can receive communicated content or shared content uploaded to the server system 102 and/or network service. In some examples, the users can interact via audio or video conferencing, audio, video, or text chat, or other communication modes or applications. In some examples, the network service can include any system allowing users to perform a variety of communications, form links and associations, upload and post shared content such as images, image compositions (e.g., albums that include one or more images, image collages, videos, etc.), audio data, and other types of content, receive various forms of data, and/or perform socially-related functions. For example, the network service can allow a user to send messages to particular or multiple other users, form social links in the form of associations to other users within the network service, group other users in user lists, friends lists, or other user groups, post or send content including text, images, image compositions, audio sequences or recordings, or other types of content for access by designated sets of users of the network service, participate in live video, audio, and/or text videoconferences or chat with other users of the service, etc. In some implementations, a “user” can include one or more programs or virtual entities, as well as persons that interface with the system or network.

A user interface can enable display of images, image compositions, data, and other content as well as communications, privacy settings, notifications, and other data on client devices 120, 122, 124, and 126 (or alternatively on server system 102). Such an interface can be displayed using software on the client device, software on the server device, and/or a combination of client software and server software executing on server device 104, e.g., application software or client software in communication with server system 102. The user interface can be displayed by a display device of a client device or server device, e.g., a display screen, projector, etc. In some implementations, application programs running on a server system can communicate with a client device to receive user input at the client device and to output data such as visual data, audio data, etc. at the client device.

In some implementations, server system 102 and/or one or more client devices 120-126 can provide integrated banking, accounting, and tax data processing functions.

Various implementations of features described herein can use any type of system and/or service. Any type of electronic device can make use of features described herein. Some implementations can provide one or more features described herein on client or server devices disconnected from or intermittently connected to computer networks.

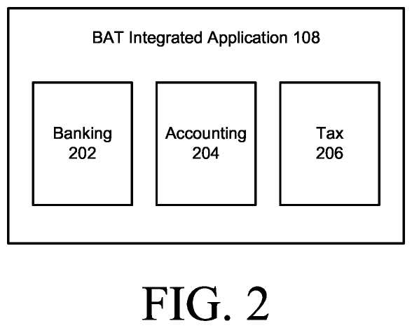

FIG. 2 is a diagram of an example banking, accounting, and tax integrated application in accordance with some implementations. The BAT integrated application 108 includes banking 202, accounting 204, and tax 206 modules integrated into the single BAT application 108. Each of the banking 202, accounting 204, and tax 206 modules provides data processing based on a single incoming stream of electronic transactions source data. Integrating the banking 202, accounting 204, and tax 206 modules as described herein provides technical solutions to technical problems described herein. The details of the data processing of the banking 202, accounting 204, and tax 206 modules are described in greater detail below.

The banking module 202 can be configured to generate customized bank statements in conformity with banking regulations with customized data made possible by the BAT integration. For example, bank statements can be customized such that transactions indicate the accounting/tax return line item category providing a correlation between the bank account and the tax return. Also, transactions can be sorted/listed according to accounting/tax return line item category providing a correlation between the bank account and the tax return. Start and end dates can be selected. Check payee names can be indicated.

The tax module 206 can process electronic transaction data based on banking and accounting inputs and tax algorithms and can be configured to automatically compute and provide notification of required tax payment due amounts and dates.

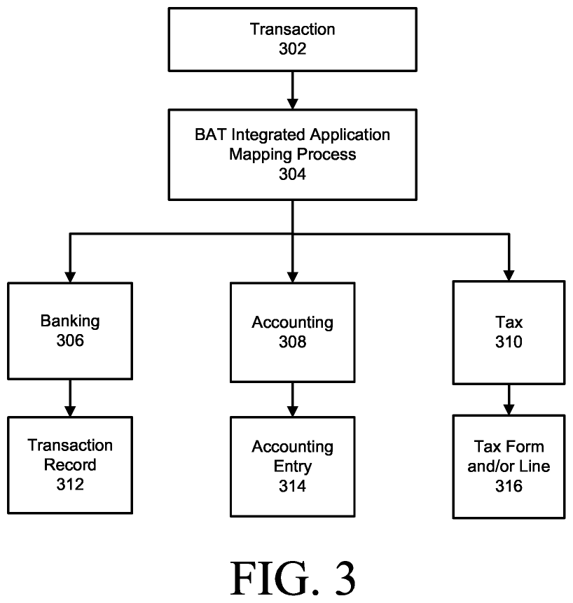

FIG. 3 is a diagram of example submodules of a banking, accounting, and tax integrated application in accordance with some implementations. As shown in FIG. 3, electronic transaction data 302 is provided as input to the BAT Integrated Application Mapping Process 304. The electronic transaction data 302 is mapped by the mapping process 304 into banking 306, accounting 308, and tax 310 modules. Within the banking module 306, the electronic transaction data 302 can be placed into or associated with a transaction record 312. Within the accounting module 308, the electronic transaction data can be placed into or associated with an accounting entry 314. Within the tax module 310, the electronic transaction data 302 can be placed into or associated with a tax form or tax form line item 316. In some implementations, the electronic transaction data 302 can be processed and mapped into banking, accounting, and tax data. In some implementations, the electronic transaction data 302 can be processed and mapped, and the data can be stored in a data base with associated data records representing the banking, accounting, and tax mapping determined by the mapping process 304.

In some implementations, the mapping process 304 can include unique automation solutions for intelligent, intuitive processing. For example, the mapping process 304 can include conditional logic. As one example, the accounting chart of accounts can be intelligently determined and pre-structured based on the type of tax return selected.

In some implementations, the mapping process 304 can include electronically and programmatically mapping of electronic transactions. For example, a digital receipt for a charge at an office supply store can be electronically captured at the point of sale/cash register then mapped by the mapping process 304 to an office supplies expense category on the tax return, with no need for a user to take a picture of the receipt with cell phone nor any other manual intervention.

The mapping process 304 can also include auto-categorization. For example, transactions can be programmatically categorized based on transaction data such as merchant industry codes, which are commonly pre-programmed by card issuers such as VISA/MC etc. Also, transactions can be programmatically categorized based on user's own previous similar entries via a machine learning model trained using categorization from the user or from other users. Further, transactions can be programmatically categorized based on other data sets such as frequent and/or large population of other users' responses or categorizations for similar transactions.

The mapping process 304 can also include utilizing optical character recognition (OCR) to extract pertinent data (e.g., payee, date, amount, memo, etc.) from checks, receipts, and other source documents to utilize in the mapping process 304.

FIG. 4 is a flowchart of an example method for integrated banking, accounting, and tax data processing in accordance with some implementations. Processing begins at 402, where a selection of a type of tax return is received. Processing continues to 404.

At 404, a chart of accounts is determined based on the tax return type. Processing continues to 406.

At 406, electronic data representing one or more transactions is received or obtained. The electronic data can include am image of a receipt, check, or other transaction documentation, electronic transaction data from a merchant or card processing service, electronic data from an external source such as a customer, supplier, etc. The Processing continues to 408.

At 408, the electronic transaction data is automatically mapped to the appropriate corresponding categories and/or entries in the integrated banking, accounting, and tax application. In some implementations, one or more aspects of the electronic data of a transaction can be programmatically analyzed and mapped to an entry in one or more of the banking, accounting, and tax data within an integrated banking, accounting, and tax system as described herein. Processing continues to 410.

At 410, banking, accounting, and/or tax documents are generated based on the mapped electronic transaction data. For example, banking documents can include bank statements. Accounting documents can include balance sheets, P and L statements, ledgers, journals, etc. Tax documents can include tax returns and associated supporting schedules or documentation.

It will be appreciated that 402 and 404 may be performed once or as needed based on changes in the tax return selection or may not be performed in some situations.

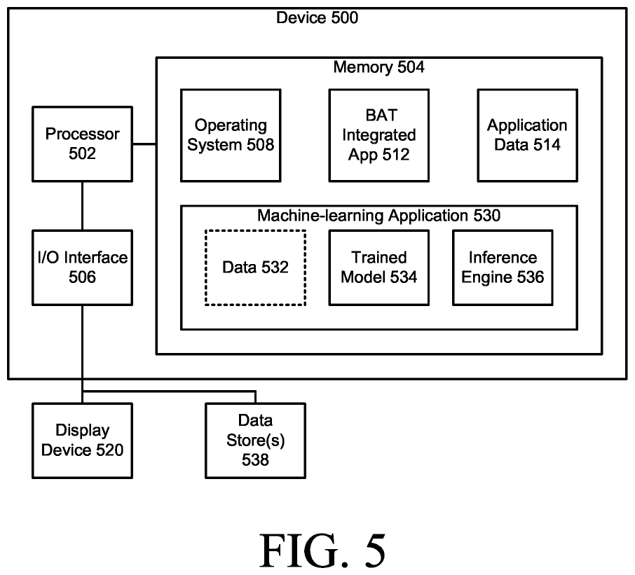

FIG. 5 is a block diagram of an example device 500 which may be used to implement one or more features described herein. In one example, device 500 may be used to implement a client device, e.g., any of client devices 120-126 shown in FIG. 1. Alternatively, device 500 can implement a server device, e.g., server device 104, etc. In some implementations, device 500 may be used to implement a client device, a server device, or a combination of the above. Device 500 can be any suitable computer system, server, or other electronic or hardware device as described above.

One or more methods described herein (e.g., FIG. 4) can be run in a standalone program that can be executed on any type of computing device, a program run on a web browser, a mobile application (“app”) run on a mobile computing device (e.g., cell phone, smart phone, tablet computer, wearable device (wristwatch, armband, jewelry, headwear, virtual reality goggles or glasses, augmented reality goggles or glasses, head mounted display, etc.), laptop computer, etc.).

In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

In some implementations, device 500 includes a processor 502, a memory 504, and I/O interface 506. Processor 502 can be one or more processors and/or processing circuits to execute program code and control basic operations of the device 500. A “processor” includes any suitable hardware system, mechanism or component that processes data, signals or other information. A processor may include a system with a general-purpose central processing unit (CPU) with one or more cores (e.g., in a single-core, dual-core, or multi-core configuration), multiple processing units (e.g., in a multiprocessor configuration), a graphics processing unit (GPU), a field-programmable gate array (FPGA), an application-specific integrated circuit (ASIC), a complex programmable logic device (CPLD), dedicated circuitry for achieving functionality, a special-purpose processor to implement neural network model-based processing, neural circuits, processors optimized for matrix computations (e.g., matrix multiplication), or other systems.

In some implementations, processor 502 may include one or more co-processors that implement neural-network processing. In some implementations, processor 502 may be a processor that processes data to produce probabilistic output, e.g., the output produced by processor 502 may be imprecise or may be accurate within a range from an expected output. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 504 is typically provided in device 500 for access by the processor 502 and may be any suitable processor-readable storage medium, such as random-access memory (RAM), read-only memory (ROM), Electrically Erasable Read-only Memory (EEPROM), Flash memory, etc., suitable for storing instructions for execution by the processor, and located separate from processor 502 and/or integrated therewith. Memory 504 can store software operating on the server device 500 by the processor 502, including an operating system 508, machine-learning application 530, banking, application, and tax (BAT) integrated application 512, and application data 514. Other applications may include applications such as a data display engine, web hosting engine, image display engine, notification engine, social networking engine, etc. In some implementations, the machine-learning application 530 and banking, application, and tax (BAT) integrated application 512 can each include instructions that enable processor 502 to perform functions described herein, e.g., some or all of the methods of FIG. 4.

The machine-learning application 530 can include one or more NER implementations for which supervised and/or unsupervised learning can be used. The machine learning models can include multi-task learning based models, residual task bidirectional LSTM (long short-term memory) with conditional random fields, statistical NER, etc. The Device can also include a banking, application, and tax (BAT) integrated application 512 as described herein and other applications. One or more methods disclosed herein can operate in several environments and platforms, e.g., as a stand-alone computer program that can run on any type of computing device, as a web application having web pages, as a mobile application (“app”) run on a mobile computing device, etc.

In various implementations, machine-learning application 530 may utilize Bayesian classifiers, support vector machines, neural networks, or other learning techniques. In some implementations, machine-learning application 530 may include a trained model 534, an inference engine 536, and data 532. In some implementations, data 432 may include training data, e.g., data used to generate trained model 534. For example, training data may include any type of data suitable for training a model for banking, application, and tax (BAT) integrated application tasks, such as images, electronic transaction data, labels, thresholds, etc. associated with transactions as described herein. Training data may be obtained from any source, e.g., a data repository specifically marked for training, data for which permission is provided for use as training data for machine-learning, etc. In implementations where one or more users permit use of their respective user data to train a machine-learning model, e.g., trained model 534, training data may include such user data. In implementations where users permit use of their respective user data, data 532 may include permitted data.

In some implementations, data 532 may include collected data such as electronic transaction data. In some implementations, training data may include synthetic data generated for the purpose of training, such as data that is not based on user input or activity in the context that is being trained, e.g., data generated from simulated conversations, computer-generated images, etc. In some implementations, machine-learning application 530 excludes data 532. For example, in these implementations, the trained model 534 may be generated, e.g., on a different device, and be provided as part of machine-learning application 530. In various implementations, the trained model 534 may be provided as a data file that includes a model structure or form, and associated weights. Inference engine 536 may read the data file for trained model 534 and implement a neural network with node connectivity, layers, and weights based on the model structure or form specified in trained model 534.

Machine-learning application 530 also includes a trained model 534. In some implementations, the trained model 534 may include one or more model forms or structures. For example, model forms or structures can include any type of neural-network, such as a linear network, a deep neural network that implements a plurality of layers (e.g., “hidden layers” between an input layer and an output layer, with each layer being a linear network), a convolutional neural network (e.g., a network that splits or partitions input data into multiple parts or tiles, processes each tile separately using one or more neural-network layers, and aggregates the results from the processing of each tile), a sequence-to-sequence neural network (e.g., a network that takes as input sequential data, such as words in a sentence, frames in a video, etc. and produces as output a result sequence), etc.

The model form or structure may specify connectivity between various nodes and organization of nodes into layers. For example, nodes of a first layer (e.g., input layer) may receive data as input data 532 or application data 514. Such data can include, for example, images, e.g., when the trained model is used for banking, application, and tax (BAT) integrated application functions. Subsequent intermediate layers may receive as input output of nodes of a previous layer per the connectivity specified in the model form or structure. These layers may also be referred to as hidden layers. A final layer (e.g., output layer) produces an output of the machine-learning application. For example, the output may be a set of labels for electronic transaction data (e.g., an image or other electronic data), an indication of a category or mapping of a transaction, etc. depending on the specific trained model. In some implementations, model form or structure also specifies a number and/or type of nodes in each layer.

In different implementations, the trained model 534 can include a plurality of nodes, arranged into layers per the model structure or form. In some implementations, the nodes may be computational nodes with no memory, e.g., configured to process one unit of input to produce one unit of output. Computation performed by a node may include, for example, multiplying each of a plurality of node inputs by a weight, obtaining a weighted sum, and adjusting the weighted sum with a bias or intercept value to produce the node output.

In some implementations, the computation performed by a node may also include applying a step/activation function to the adjusted weighted sum. In some implementations, the step/activation function may be a nonlinear function. In various implementations, such computation may include operations such as matrix multiplication. In some implementations, computations by the plurality of nodes may be performed in parallel, e.g., using multiple processors cores of a multicore processor, using individual processing units of a GPU, or special-purpose neural circuitry. In some implementations, nodes may include memory, e.g., may be able to store and use one or more earlier inputs in processing a subsequent input. For example, nodes with memory may include long short-term memory (LSTM) nodes. LSTM nodes may use the memory to maintain “state” that permits the node to act like a finite state machine (FSM). Models with such nodes may be useful in processing sequential data, e.g., words in a sentence or a paragraph, frames in a video, speech or other audio, etc.

In some implementations, trained model 534 may include embeddings or weights for individual nodes. For example, a model may be initiated as a plurality of nodes organized into layers as specified by the model form or structure. At initialization, a respective weight may be applied to a connection between each pair of nodes that are connected per the model form, e.g., nodes in successive layers of the neural network. For example, the respective weights may be randomly assigned, or initialized to default values. The model may then be trained, e.g., using data 532, to produce a result.

For example, training may include applying supervised learning techniques. In supervised learning, the training data can include a plurality of inputs (e.g., a set of images) and a corresponding expected output for each input (e.g., one or more labels for each image representing aspects of a transaction source document corresponding to the images such as one or more transactions). Based on a comparison of the output of the model with the expected output, values of the weights are automatically adjusted, e.g., in a manner that increases a probability that the model produces the expected output when provided similar input.

In some implementations, training may include applying unsupervised learning techniques. In unsupervised learning, only input data may be provided, and the model may be trained to differentiate data, e.g., to cluster input data into a plurality of groups, where each group includes input data that are similar in some manner. For example, the model may be trained to identify source document transaction task labels that are associated with images and/or select thresholds for transaction identification and mapping.

In another example, a model trained using unsupervised learning may cluster words based on the use of the words in data sources. In some implementations, unsupervised learning may be used to produce knowledge representations, e.g., that may be used by machine-learning application 530. In various implementations, a trained model includes a set of weights, or embeddings, corresponding to the model structure. In implementations where data 532 is omitted, machine-learning application 530 may include trained model 534 that is based on prior training, e.g., by a developer of the machine-learning application 530, by a third-party, etc. In some implementations, trained model 534 may include a set of weights that are fixed, e.g., downloaded from a server that provides the weights.

Machine-learning application 530 also includes an inference engine 536. Inference engine 536 is configured to apply the trained model 534 to data, such as application data 514, to provide an inference. In some implementations, inference engine 536 may include software code to be executed by processor 502. In some implementations, inference engine 536 may specify circuit configuration (e.g., for a programmable processor, for a field programmable gate array (FPGA), etc.) enabling processor 502 to apply the trained model. In some implementations, inference engine 536 may include software instructions, hardware instructions, or a combination. In some implementations, inference engine 536 may offer an application programming interface (API) that can be used by operating system 508 and/or banking, application, and tax (BAT) integrated application 512 to invoke inference engine 536, e.g., to apply trained model 534 to application data 514 to generate an inference.

Machine-learning application 530 may provide several technical advantages. For example, when trained model 534 is generated based on unsupervised learning, trained model 534 can be applied by inference engine 536 to produce knowledge representations (e.g., numeric representations) from input data, e.g., application data 514. For example, a model trained for integrated banking, accounting, and tax data processing tasks may produce predictions and confidences for given input information about a transaction. A model trained for suggesting integrated banking, accounting, and tax data processing tasks or transaction categories or mappings in integrated banking, accounting, and tax data processing tasks may produce a prediction or suggestion for integrated banking, accounting, and tax data processing tasks on input images or other information. In some implementations, such representations may be helpful to reduce processing cost (e.g., computational cost, memory usage, etc.) to generate an output (e.g., a suggestion, a prediction, a classification, etc.). In some implementations, such representations may be provided as input to a different machine-learning application that produces output from the output of inference engine 536.

In some implementations, knowledge representations generated by machine-learning application 530 may be provided to a different device that conducts further processing, e.g., over a network. In such implementations, providing the knowledge representations rather than the images may provide a technical benefit, e.g., enable faster data transmission with reduced cost. In another example, a model trained for integrated banking, accounting, and tax data processing tasks may produce a signal for one or more images being processed by the model.

In some implementations, machine-learning application 530 may be implemented in an offline manner. In these implementations, trained model 534 may be generated in a first stage and provided as part of machine-learning application 530. In some implementations, machine-learning application 530 may be implemented in an online manner. For example, in such implementations, an application that invokes machine-learning application 530 (e.g., operating system 508, one or more of banking, application, and tax (BAT) integrated application 512 or other applications) may utilize an inference produced by machine-learning application 530, e.g., provide the inference to a user, and may generate system logs (e.g., if permitted by the user, an action taken by the user based on the inference; or if utilized as input for further processing, a result of the further processing). System logs may be produced periodically, e.g., hourly, monthly, quarterly, etc. and may be used, with user permission, to update trained model 534, e.g., to update embeddings for trained model 534.

In some implementations, machine-learning application 530 may be implemented in a manner that can adapt to particular configuration of device 500 on which the machine-learning application 530 is executed. For example, machine-learning application 430 may determine a computational graph that utilizes available computational resources, e.g., processor 502. For example, if machine-learning application 530 is implemented as a distributed application on multiple devices, machine-learning application 530 may determine computations to be carried out on individual devices in a manner that optimizes computation. In another example, machine-learning application 530 may determine that processor 502 includes a GPU with a particular number of GPU cores (e.g., 1000) and implement the inference engine accordingly (e.g., as 1000 individual processes or threads).

In some implementations, machine-learning application 530 may implement an ensemble of trained models. For example, trained model 534 may include a plurality of trained models that are each applicable to same input data. In these implementations, machine-learning application 530 may choose a particular trained model, e.g., based on available computational resources, success rate with prior inferences, etc. In some implementations, machine-learning application 530 may execute inference engine 536 such that a plurality of trained models is applied. In these implementations, machine-learning application 530 may combine outputs from applying individual models, e.g., using a voting-technique that scores individual outputs from applying each trained model, or by choosing one or more particular outputs. Further, in these implementations, machine-learning application may apply a time threshold for applying individual trained models (e.g., 0.5 ms) and utilize only those individual outputs that are available within the time threshold. Outputs that are not received within the time threshold may not be utilized, e.g., discarded. For example, such approaches may be suitable when there is a time limit specified while invoking the machine-learning application, e.g., by operating system 508 or one or more other applications, e.g., banking, application, and tax (BAT) integrated application 512.

In different implementations, machine-learning application 530 can produce different types of outputs. For example, machine-learning application 530 can provide representations or clusters (e.g., numeric representations of input data), labels (e.g., for input data that includes images, documents, etc.), phrases or sentences (e.g., descriptive of an image or video, suitable for use as a response to an input sentence, suitable for use to determine context during a conversation, etc.), images (e.g., generated by the machine-learning application in response to input), audio or video (e.g., in response an input video, machine-learning application 530 may produce an output video with a particular effect applied, e.g., rendered in a comic-book or particular artist's style, when trained model 534 is trained using training data from the comic book or particular artist, etc. In some implementations, machine-learning application 530 may produce an output based on a format specified by an invoking application, e.g., operating system 508 or one or more applications, e.g., banking, application, and tax (BAT) integrated application 512. In some implementations, an invoking application may be another machine-learning application. For example, such configurations may be used in generative adversarial networks, where an invoking machine-learning application is trained using output from machine-learning application 530 and vice-versa.

Any of software in memory 504 can alternatively be stored on any other suitable storage location or computer-readable medium. In addition, memory 504 (and/or other connected storage device(s)) can store one or more messages, one or more taxonomies, electronic encyclopedia, dictionaries, thesauruses, knowledge bases, message data, grammars, user preferences, and/or other instructions and data used in the features described herein. Memory 504 and any other type of storage (magnetic disk, optical disk, magnetic tape, or other tangible media) can be considered “storage” or “storage devices.”

I/O interface 506 can provide functions to enable interfacing the server device 500 with other systems and devices. Interfaced devices can be included as part of the device 500 or can be separate and communicate with the device 500. For example, network communication devices, storage devices (e.g., memory and/or database 106), and input/output devices can communicate via I/O interface 506. In some implementations, the I/O interface can connect to interface devices such as input devices (keyboard, pointing device, touchscreen, microphone, camera, scanner, sensors, etc.) and/or output devices (display devices, speaker devices, printers, motors, etc.).

Some examples of interfaced devices that can connect to I/O interface 506 can include one or more display devices 520 and one or more data stores 538 (as discussed above). The display devices 520 that can be used to display content, e.g., a user interface of an output application as described herein. Display device 520 can be connected to device 500 via local connections (e.g., display bus) and/or via networked connections and can be any suitable display device. Display device 520 can include any suitable display device such as an LCD, LED, or plasma display screen, CRT, television, monitor, touchscreen, 3-D display screen, or other visual display device. For example, display device 520 can be a flat display screen provided on a mobile device, multiple display screens provided in a goggles or headset device, or a monitor screen for a computer device.

The I/O interface 506 can interface to other input and output devices. Some examples include one or more cameras which can capture images. Some implementations can provide a microphone for capturing sound (e.g., as a part of captured images, voice commands, etc.), audio speaker devices for outputting sound, or other input and output devices.

For ease of illustration, FIG. 5 shows one block for each of processor 502, memory 504, I/O interface 506, and software blocks 508, 512, and 530. These blocks may represent one or more processors or processing circuitries, operating systems, memories, I/O interfaces, applications, and/or software modules. In other implementations, device 500 may not have all of the components shown and/or may have other elements including other types of elements instead of, or in addition to, those shown herein. While some components are described as performing blocks and operations as described in some implementations herein, any suitable component or combination of components of environment 100, device 500, similar systems, or any suitable processor or processors associated with such a system, may perform the blocks and operations described.

In some implementations, logistic regression can be used for personalization (e.g., integrated banking, accounting, and tax data processing task suggestions based on a user's pattern of activity). In some implementations, the prediction model can be handcrafted including hand selected labels and thresholds. The mapping (or calibration) from ICA space to a predicted precision within the integrated banking, accounting, and tax data processing tasks space can be performed using a piecewise linear model.

In some implementations, the integrated banking, accounting, and tax data processing system could include a machine-learning model (as described herein) for tuning the system (e.g., selecting labels and corresponding thresholds) to potentially provide improved accuracy. Inputs to the machine learning model can include ICA labels, an image descriptor vector that describes appearance and includes semantic information about electronic transaction data. Example machine-learning model input can include labels for a simple implementation and can be augmented with descriptor vector features for a more advanced implementation. Output of the machine-learning module can include a prediction of transaction categorization and mapping.

One or more methods described herein (e.g., method of FIG. 4) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating system.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving one or more electronic data items representing one or more corresponding transactions;
programmatically mapping each of the one or more transactions to corresponding entries in banking, accounting and tax data; and
automatically updating banking, accounting, and tax data based on the received electronic data and the programmatic mapping.

2. The computer implemented method of claim 1, wherein programmatically mapping includes:
when data correspond to one of the one or more corresponding transactions includes an image, performing an optical character recognition operation on the image to extract one or more items of information from the image to utilize in the programmatically mapping.

3. The computer implemented method of claim 1, wherein programmatically mapping includes
categorizing the one or more transactions based on one or more of a merchant industry code.

4. The computer implemented method of claim 1, wherein programmatically mapping includes
categorizing the one or more transactions based on previous categorization of similar transactions by one or more users.

5. The computer implemented method of claim 1, wherein programmatically mapping includes
categorizing the one or more transactions based on a machine learning model signal, where the machine learning model is trained to predict categorization using previous categorization of one or more transactions.

6. The computer implemented method of claim 1, further comprising generating a bank statement that includes one or more of accounting information or tax return line item category corresponding to a transaction in the bank statement.

7. The computer implemented method of claim 1, further comprising:
computing a required tax payment and corresponding due date based on programmatically mapping and automatically updating; and
generating a notification of the required tax payment and due date.

8. A system comprising:
one or more processors coupled to a computer-readable medium having stored thereon software instructions that, when executed by the one or more processors, cause the one or more processors to perform operations including:
receiving one or more electronic data items representing one or more corresponding transactions;
programmatically mapping each of the one or more transactions to corresponding entries in banking, accounting and tax data; and
automatically updating banking, accounting, and tax data based on the received electronic data and the programmatic mapping.

9. The system of claim 8, wherein the programmatically mapping includes:
when data correspond to one of the one or more corresponding transactions includes an image, performing an optical character recognition operation on the image to extract one or more items of information from the image to utilize in the programmatically mapping.

10. The system of claim 8, wherein programmatically mapping includes categorizing the one or more transactions based on one or more of a merchant industry code.

11. The system of claim 8, wherein programmatically mapping includes categorizing the one or more transactions based on previous categorization of similar transactions by one or more users.

12. The system of claim 8, wherein programmatically mapping includes categorizing the one or more transactions based on a machine learning model signal, where the machine learning model is trained to predict categorization using previous categorization of one or more transactions.

13. The system of claim 8, further comprising generating a bank statement that includes one or more of accounting information or tax return line item category corresponding to a transaction in the bank statement.

14. The system of claim 8, further comprising:
computing a required tax payment and corresponding due date based on the programmatically mapping and automatically updating; and
generating a notification of the required tax payment and due date.

15. A computer-readable medium having stored thereon software instructions that, when executed by one or more processors, cause the one or more processors to perform operations including:
receiving one or more electronic data items representing one or more corresponding transactions;
programmatically mapping each of the one or more transactions to corresponding entries in banking, accounting and tax data; and
automatically updating banking, accounting, and tax data based on the received electronic data and the programmatic mapping.

16. The computer-readable medium of claim 15, wherein programmatically mapping includes:
when data correspond to one of the one or more corresponding transactions includes an image, performing an optical character recognition operation on the image to extract one or more items of information from the image to utilize in the programmatically mapping.

17. The computer-readable medium of claim 15, wherein programmatically mapping includes categorizing the one or more transactions based on one or more of a merchant industry code.

18. The computer-readable medium of claim 15, wherein programmatically mapping includes categorizing the one or more transactions based on previous categorization of similar transactions by one or more users.

19. The computer-readable medium of claim 15, wherein programmatically mapping includes categorizing the one or more transactions based on a machine learning model signal, where the machine learning model is trained to predict categorization using previous categorization of one or more transactions.

20. The computer-readable medium of claim 15, further comprising generating a bank statement that includes one or more of accounting information or tax return line item category corresponding to a transaction in the bank statement.
